(19) United States
(12) Patent Application Publication
(10) Pub. No.: US 2006/0219277 A1
(43) Pub. Date: Oct. 5, 2006

(54) Substrate-treating apparatus

(75) Inventors: Kenichiro Nakamura, Fukuoka (JP); Tsuyoshi Hirayama, Fukuoka (JP); Minoru Momodomi, Fukuoka (JP); Kenji Kiyokawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA YASKAWA DENKI, Fukuoka (JP)

(21) Appl. No.: 10/564,728

(22) PCT Filed: Jul. 16, 2004
(86) PCT No.: PCT/JP04/10563

§ 371 Date: Jan. 17, 2006

(30) Foreign Application Priority Data
Jul. 16, 2003 (JP) 2003-275390

(51) Int. Cl. B08B 3/00

(52) U.S. Cl. 134/137; 134/149

(57) ABSTRACT

To provide a substrate treating apparatus for keeping a substrate in contact with a treating tool under a prescribed pressure.

According to this invention, a bracket 10 which is hoisted or lowered by a hoisting/lowering device 15 is provided with a treating tool 3 for carrying out the treatment such as cleaning for the surface of a substrate in contact with the surface under a prescribed pressure therefor, an operating shaft 4 with the treating tool 3 attached thereto, a holding member 6 for holding the operating shaft 4 freely only in its rotating direction, a servomotor 11 coupled to the holding member 6, for moving up and down the operating shaft 4, and a rotary motor 8 coupled with the operating shaft 4 through a pin joint 9. Separately from the hoisting/lowering device 15 for the bracket 10, the servo motor 11 for moving up and down the operating shaft 4 is provided. The servo motor is excited according to the difference between the weight of the operating shaft 4 inclusive of the treating tool 3 and a prescribed contact pressure or weight so that an output torque is applied to the operating shaft 4 to cancel the weight of the operating shaft 4, thereby keeping the treating tool 3 in contact with the substrate surface with the weight corresponding to the prescribed contact pressure.

### TECHNICAL FIELD

This invention relates to a substrate treating apparatus for treating the surface of a substrate such a semiconductor wafer.

### RELATED ART

Traditionally, where the surface of a semiconductor wafer, a substrate for a liquid crystal display device, etc. is subjected to the treatment such as cleaning or grinding, it is necessary to accurately keep the pressure of a treating tool, e.g. nozzle or cleaning brush, applied to the substrate surface.

To this end, as shown in FIG. 2, the substrate treating apparatus includes a swing arm 32 equipped with a cleaning tool 31 opposite to a substrate 1, and a bracket 34 with a swing motor 33 for operating the swing arm 32. In operation, the bracket 34 is moved up and down by a servo motor 36 through a hoisting/lowering device, e.g. ball screw so that the cleaning tool 31 is moved to a predetermined height. A prescribed value corresponding to the height of the cleaning tool 31 is supplied to a controller to compute the number of revolutions of the servo motor 36. The servo motor 36 is rotated according to the computed number of revolutions. The number of revolutions is detected by a rotary encoder 37 and fed back to the controller. Thus, the cleaning tool 31 is moved to a set height (JP-A-11-283950).

In another surface treating apparatus, by moving a cleaning brush up and down to be brought into contact with a pressure sensor seated at another position separate from a wafer, the height of the cleaning brush when its pressure reaches a basic pressure is detected. By increasing or decreasing the difference between the position of the pressure sensor and the height of the plane on which the substrate is seated, the height of the cleaning brush when it is opposed to the substrate is also detected. And the entire device including the rotary motor for the cleaning brush is moved up and down to apply a predetermined pressure to the substrate (JP-A-10-135167).

As described above, in the conventional substrate treating apparatus, the up-and-down movement for adjusting the position or pressure of the treating tool such as the cleaning brush is carried out in such a manner that the entire bracket equipped with the treating tool is moved up and down by an air cylinder or servo motor and the detected amount of the movement is fed back, thereby bring the treating tool into contact with the substrate surface according to a prescribed value. Likewise, the height adjustment for adjusting a contact pressure is, also carried out by the up-and-down movement of the entire bracket.

However, in these substrate treating apparatus, the weight of the entire device which supports the treating tool and swing arm is increased and the gap and backlash of each components in mechanism is accumulated. This is likely to generate the lag or error in control. As a result, even if feedback control is carried out, it is difficult to accurately control the distance from the substrate and the pressure applied to the substrate.

In view of the above circumstance, an object of this invention is to finely and easily adjust and keep the contact pressure between a substrate and a treating tool by providing a hoisting/lowering device for moving the entire treating tool to a prescribed height and a device for moving up and down an operating shaft for adjusting/keeping the pressure of the treating tool.

### DISCLOSURE OF THE INVENTION

In order to attain the above object, this invention provides a substrate treating apparatus including: a treating tool for carrying out the treatment such as cleaning for the surface of a substrate while keeping a prescribed pressure for the substrate; an operating shaft with the treating tool attached thereto; a bracket for supporting the operating shaft; an attaching frame for swingably supporting the bracket; a hoisting/lowering device for hoisting/lowering the attaching frame; a holding member for holding the operating shaft freely only in a rotating direction; and a servomotor coupled to the holding member, for applying torque to the operating shaft, so that a contact pressure between the treating tool and the substrate are adjusted using the torque of the servo motor, wherein the operating shaft is attached to the bracket so as to be movable up and down integrally to the treating tool.

Additionally, in the above substrate treating apparatus, the servo motor applies the torque corresponding to difference between the weight of the treating tool inclusive of the operating shaft and a prescribed contact pressure or weight to the operating shaft.

Further, the operating shaft is coupled with the rotary motor through a pin joint so that the weight of the rotary motor is not applied to the operating shaft, and there are further provided the holding member for holding the operating shaft freely only in its rotating direction and the servomotor coupled to the holding member, for applying torque to the operating shaft.

In accordance with this invention, separately from the hoisting/lowering device for hoisting/lowering an entire attaching frame, there are provided the holding member for holding the operating shaft so that it can be moved integrally to the treating tool in a vertical direction and moved freely only in the rotary direction, and the servo motor coupled with the holding member so that the weight of the operating shaft is cancelled by the torque of the servo motor, thereby bringing the operating shaft into contact with the substrate with the weight corresponding to the prescribed pressure. Thus, the treating tool can be kept in contact with the substrate surface under the prescribed pressure. Accordingly, even when the position of the upper surface of the substrate is changed by the rotation of the substrate chuck, the operating shaft can kept in contact with the substrate surface under the prescribed pressure.

Further, by adjusting the torque of the servo motor, the contact pressure can be accurately adjusted in units of e.g. 1 gram. In addition, since the weight of the operating shaft is small the contact pressure can be adjusted quickly and accurately.

Further, it is not necessary to precisely move the position of the entire attaching frame, thereby simplifying the structure and operation of the hoisting/lowering device.

Additionally, by coupling the operating shaft with the rotary motor though the pin joint so that the weight of the rotary motor is not applied to the operating shaft, the torque applied to the operating shaft can be decreased, thereby downsizing the servo motor and facilitating the adjustment thereof.

### BRIEF DESCRIPTION OF THE DRAWINGS

FIG. 1 is a side sectional view showing a schematic configuration of an embodiment of this invention.

FIG. 2 is a side view showing a conventional configuration.

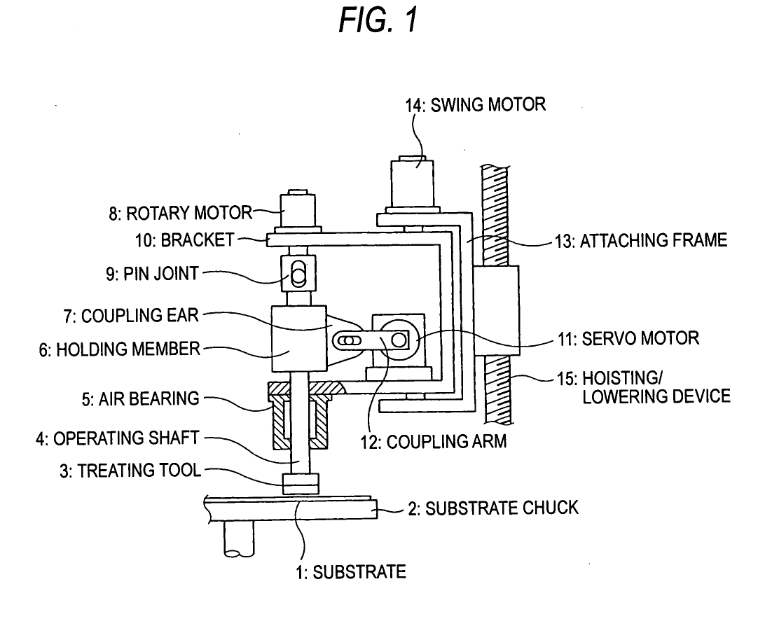

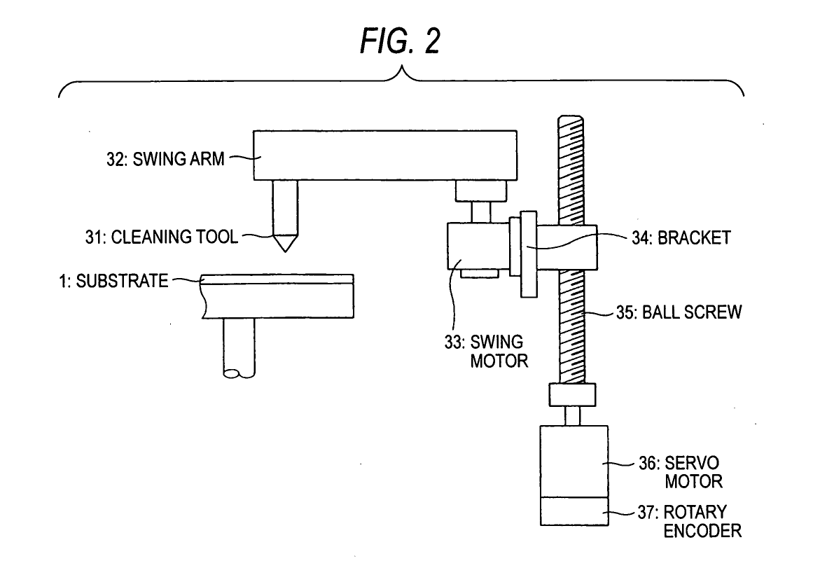

In FIG. 1, reference numeral 1 denotes a substrate; 2 a substrate chuck; 3 a treating tool; 4 an operating shaft; 5 an air bearing; 6 a holding member; 7 a coupling ear; 8 a rotary motor; 9 a pin joint; 10 a bracket; 11 a servo motor; 12 a coupling arm; 13 an attaching frame; 14 a swing motor; and 15 a hoisting/lowering device.

### BEST MODE FOR CARRYING OUT THE INVENTION

Now referring to the drawing, an explanation will be given of an embodiment of this invention.

In FIG. 1, reference numeral 1 denotes the substrate 1 attached to the substrate chuck 2. Reference numeral 3 denotes the treating tool such as a cleaning brush. Reference numeral 4 is an operating shaft to which the treating tool 3 is attached. Reference numeral 5 is an air bearing. Reference numeral 6 is the holding member for holding the operating shaft 4, which holds the operating shaft 4 so as move freely in the rotating direction and integrally to the holding member 6 in the axial direction. Reference numeral 7 is a coupling ear provided on the side of the holding member. Reference numeral 8 is a rotary motor for the operating shaft, which is coupled with the operating shaft 4 through the pin joint 9 so that the operating shaft 4 can be slightly moved in the axial direction. Thus, the weight of the rotary motor 8 is not applied to the operating shaft 4. Reference numeral 10 is the bracket to which the operating shaft 4 and the rotary motor 8 are attached. Reference numeral 11 is the servo motor attached to the bracket 10, which may be a torque motor linearly changing an output torque for an exciting current. Reference numeral 12 is the coupling arm whose one end is fixed to the shaft of the servo motor 11 and whose other end is pin-coupled with the coupling ear 7. Reference numeral 13 is the attaching frame provided with the swing motor 14 for swinging the bracket 10, which is moved up and down by the hoisting/lowering device 15.

The attaching frame 13 is lowered to a stopper (not shown) at a predetermined position by the hoisting/lowering device 15, e.g. screw shaft so that the treating tool, e.g. cleaning brush 3 is moved to a position opposite to the upper surface of the substrate 1. In this case, unlike the conventional device, it is not necessary to accurately move the treating tool 3 to a predetermined position for the substrate 1 with the servo motor for the hoisting/lowering device being in agreement with a prescribed value using the detected signal from the rotary encoder, but has only to move within a range of the up-and-down movement of the operating shaft 4.

The operating shaft 4 including the treating tool 3 is supported by the air bearing 5, separated from the rotary motor 8 by the pin joint 9 and coupled with the servo motor 11 through the holding member 6. By exciting the servo motor 11 with an exciting current corresponding to the value (G−g) obtained when the weight g corresponding to a predetermined contact pressure is subtracted from the weight G of the operating shaft 4 inclusive of the treating tool 3, a torque (G−g) is applied to the operating shaft 4 through the holding member 6 in a direction of lifting the operating shaft 4. Thus, the weight (G−g) corresponding to the torque is subtracted from the weight G of the operating shaft 4 so that the weight acting in the lowering direction of the operating shaft 4 becomes g. As a result, the treating tool 3 is lowered by the weight g of the operating shaft 4 so that it is contact-held on the substrate 1 with a predetermined pressure corresponding to the weight

The control of the servo motor 11 can be carried out through the feedback control by inputting the weight G of the operating shaft 4 and the prescribed contact pressure g as set values and computing an exciting current so that the output torque is (G−g).

In this way, by applying the torque of the servo motor 11 to the operating shaft 4, the weight of the operating shaft 4 is cancelled to be held to the weight corresponding to the prescribed pressure value. Thus, the operating shaft 4 can be brought into contact with the substrate 1 under the prescribed pressure so that even the position of the substrate is changed, the contact pressure can be always held to a constant value.

Incidentally, during cleaning, a cleaning fluid flows in between the treating tool 3 and the substrate 1 so that a minute gap is generated therebetween. In this case also, the contact pressure can be held through the membrane of the cleaning fluid.

Further, the operating shaft 4 can be directly coupled with the rotary motor 8 to add the weight of the rotary motor 8. However, in this case, excessive weight is applied to the treating tool. For this reason, in the embodiment of FIG. 1, the operating shaft 4 and the rotary motor 8 are coupled by the pin joint 9 so that they can be moved slightly in the axial direction. Thus, the operating shaft 4 and rotary motor 8 can be separated so that the weight of the operating shaft 4 inclusive of the treating tool 3 is decreased, thereby reducing the torque of the servo motor 11.

### INDUSTRIAL APPLICABILITY

As described above, in accordance with this invention, separately, from the hoisting/lowering device for hoisting/lowering an entire attaching frame, there are provided the holding member for holding the operating shaft so that it can be moved integrally to the treating tool in the vertical direction and moved freely only in the rotary direction, and the servo motor coupled with the holding member so that the weight of the operating shaft is cancelled by the torque of the servo motor, thereby bringing the operating shaft into contact with the substrate with the weight corresponding to the prescribed pressure. Thus, the treating tool can be kept in contact with the substrate surface under the prescribed pressure. Accordingly, even when the position of the upper surface of the substrate is changed by the rotation of the substrate chuck, the operating shaft can kept in contact with the substrate surface under the prescribed pressure.

Further, by adjusting the torque of the servo motor, the contact pressure can be accurately adjusted in units of e.g. 1 gram. In addition, since the weight of the operating shaft is small, the contact pressure can be adjusted quickly and accurately.

Further, it is not necessary to precisely move the position of the entire attaching frame, thereby simplifying the structure and operation of the hoisting/lowering device.

Additionally, by coupling the operating shaft with the rotary motor though the pin joint so that the weight of the rotary motor is not applied to the operating shaft, the torque applied to the operating shaft can be decreased, thereby downsizing the servo motor and facilitating the adjustment thereof.

1. A substrate treating apparatus comprising:
a treating tool for carrying out the treatment such as cleaning for the surface of a substrate while keeping a prescribed pressure for the substrate;
an operating shaft with the treating tool attached thereto;
a bracket for supporting the operating shaft;
an attaching frame for swingably supporting the bracket;
a hoisting/lowering device for hoisting/lowering the attaching frame;
a holding member for holding the operating shaft freely only in a rotating direction; and
a servomotor coupled to the holding member, for applying torque to the operating shaft, so that a contact pressure between the treating tool and the substrate are adjusted using the torque of the servo motor, wherein
the operating shaft is attached to the bracket so as to be movable up and down integrally to the treating tool.

2. The substrate treating apparatus according to claim 1, wherein the servo motor applies the torque corresponding to difference between the weight of the treating tool inclusive of the operating shaft and a prescribed contact pressure or weight to the operating shaft.

3. The substrate treating apparatus according to claim 1, further comprising:
a holding member for holding the operating shaft freely only in a rotating direction; and
a servomotor coupled to the holding member, for applying torque to the operating shaft, wherein
the operating shaft is coupled with the rotary motor through a pin joint so that the weight of the rotary motor is not applied to the operating shaft.

4. The substrate treating apparatus according to claim 2, further comprising:
a holding member for holding the operating shaft freely only in a rotating direction; and
a servomotor coupled to the holding member, for applying torque to the operating shaft, wherein
the operating shaft is coupled with the rotary motor through a pin joint so that the weight of the rotary motor is not applied to the operating shaft.
